(19) United States
(12) Patent Application Publication
(10) Pub. No.: US 2011/0228644 A1
(43) Pub. Date: Sep. 22, 2011

(54) Detachable Clock and Gear Assembly Structure

(76) Inventor: Ming Hui CHANG, Taipei (TW)

(21) Appl. No.: 12/729,228

(22) Filed: Mar. 22, 2010

(51) Int. Cl. G04B 15/00

(52) U.S. Cl. 368/127

(57) ABSTRACT

The present invention relates to an improved detachable clock and watch gear assembly structure, which divides the gear assembly into detachable and independent first and second devices; the first device comprises: main and pinion gear representing hour, minute and second hands, spiral spring wheel for storing energy and spiral spring for ringing; the second device comprises: time-controlled precision escapement wheel, pallet, balance spring and balance wheel; of which, the first device can clamp securely the main and pinion gears as well as spiral spring by using upper/lower plywood along with the fixed leg, so can the second device clamp securely the escapement wheel, pallet, balance spring and balance wheel in the same way; an fixed arm is extended from the upper/lower plywood at one side of the first device to clamp the second device and fix it by bolt for meshing and interlocking purpose; with this design, the first device can be checked or replaced in common repair or replacement process, helping to avoid error disassembly of the precision second device and difficult alignment or otherwise malfunction for easier and quicker assembly purpose.

### BACKGROUND OF INVENTION

1. Field of the Invention

The present invention relates generally to a detachable clock and gear assembly structure, and more particularly to an innovative one which provides a first and a second clip for superposition of the parts, so as to address the inconvenience of aligning the parts with the mating holes and improve the ease-of-operation and practicability.

2. Description of Related Art

The clocks or watches are generally maintained in such a procedure including: disassembly, cleaning, assembly, lubrication and examination, which have to be performed by skilled technicians due to demanding quality requirements.

Apart from power supply or quartz oscillation, the gear assembly 1 in most of clocks or watches, as shown in FIG. 1, is generally energized by spiral spring; so the spiral spring is of utmost importance to the mechanical clocks or watches, as the case may be for maintenance of parts or replacement of products after the movement mechanism is fully disassembled. And, particular attentions must be paid to time-controlled escapement wheel 31, pallet 32, balance spring 33 and balance wheel 34 within the gear assembly 1, all of which are precision parts requiring extremely careful disassembly and assembly for normal operation; otherwise, any improper disassembly or assembly will lead to damage of parts or malfunction, making it difficult for the beginners or unskilled maintenance staff. Secondly, common faults of clocks or watches, such as: stopping and falling of pointer, damage and breakage of spiral spring, etc, could be solved by the beginners or unskilled persons for the lubrication and replacement, but the adjustment, disassembly or replacement of precision control mechanism have to be performed by skilled technicians. However, said movement mechanism is designed structurally in such a way that the upper and lower plywoods 25, 26 are used for fixation of the main and pinion gears 21, 22 representing hour, minute and second hands, the spiral spring wheel 23 for storing energy and spiral spring 24 for ringing, as well as aforementioned escapement wheel 31, pallet 32, balance spring 33 and balance wheel 34; in case the upper and lower plywoods are removed, all parts are vulnerable to falling-off; besides, all parts must be aligned or mated with the plywoods for easier repair or maintenance with excellent patience and qualifications. This brings about troublesome repair or maintenance of the movement mechanism.

However, huge investment and great efforts have to be made for fostering experienced professionals; in such case, streamlining the time-consuming repair or maintenance process can solve the bottleneck of the client for lack of professionals.

Thus, to overcome the aforementioned problems of the prior art, it would be an advancement if the art to provide an improved structure that an significantly improve the efficacy.

Therefore, the inventor has provided the present invention of practicability after deliberate design and evaluation based on years of experience in the production, development and design of related products.

### CONTENT OF INVENTION

The main objective of the present invention is to provide an improved detachable clock and gear assembly structure, which divides the movement mechanism into a simple first device and a precision second device, both of which can be disassembled and assembled easily; when the devices are disassembled, the first device is intended for practice of disassembly and assembly by the beginners or unskilled persons, and the second device for rapid disassembly and assembly after accumulation of enough experience; this can avoid misalignment and error assembly as well as malfunction arising from error disassembly of the second device, meanwhile it can simplify the repair and maintenance process, and improve significantly the working efficiency when faced with the shortage of professionals.

For the aforementioned purpose, the present invention provides an improved clock and watch gear assembly structure, which divides the movement mechanism into detachable and also independent first and second devices, of which the first device comprises: main and pinion gears representing hour, minute and second hands, the spiral spring wheel for storing energy and spiral spring for ringing; the second device comprises time-controlled escapement wheel, pallet, balance spring and balance wheel. Of which, the first device can clamp securely the main and pinion gears as well as spiral spring by using upper/lower plywood along with the fixed leg, so can the second device clamp securely the escapement wheel, pallet, balance spring and balance wheel in the same way; moreover, an fixed arm is extended from the upper/lower plywood at one side of the first device to clamp the second device and fix it by bolt for meshing and interlocking purpose.

The features and the advantages of the present invention will be more readily understood upon a thoughtful deliberation of the following detailed description of a preferred embodiment of the present invention with reference to the accompanying drawings.

### BRIEF DESCRIPTION OF THE DRAWINGS

FIG. 1 shows a lateral view of the gear assembly of the typical clock and watch.

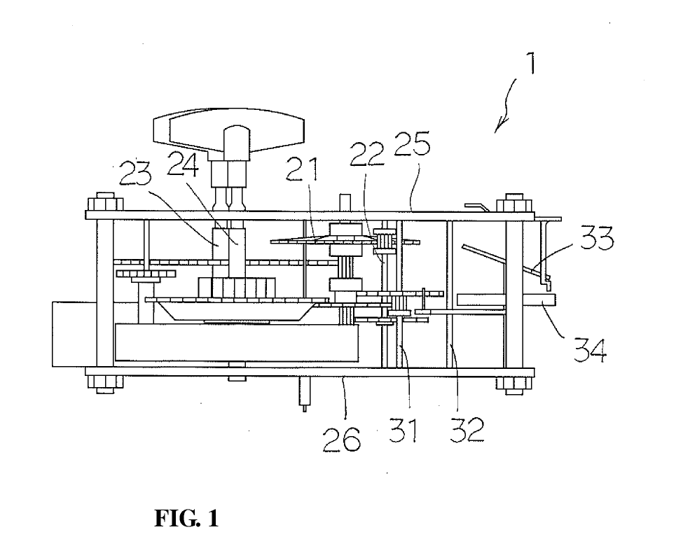

FIG. 2 shows an exploded lateral view of the preferred embodiment of the gear assembly of the present invention.

FIG. 3 shows an assembled lateral view of the preferred embodiment of the gear assembly of the present invention.

### DETAILED DESCRIPTION OF THE INVENTION

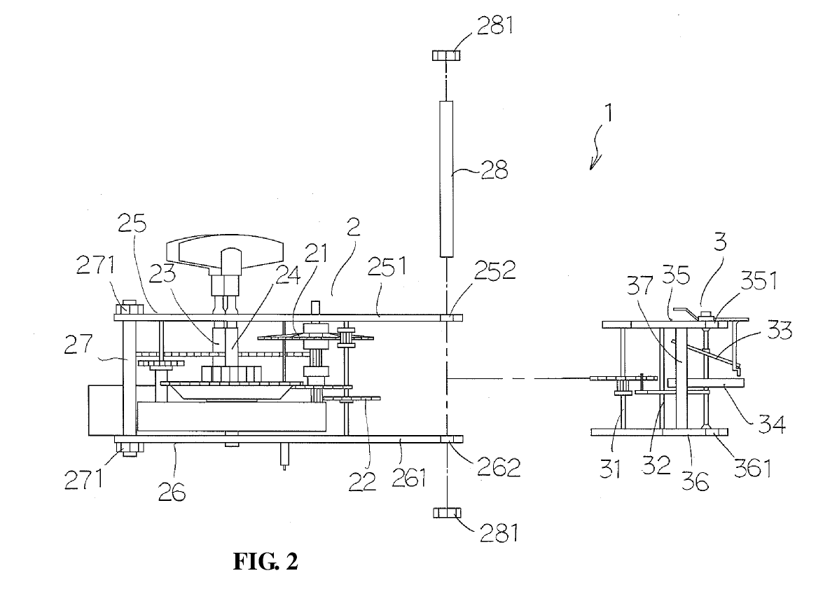

Referring to FIG. 2—an exploded lateral view of the preferred embodiment of the gear assembly of the present invention, the gear assembly 1 of the clock and watch is divided into detachable and also independent first device 2 and second device 3, of which:

the first device 2 comprises: the main and pinion gears 21, 22 representing hour, minute and second hands, the spiral spring wheel 23 for storing energy and spiral spring 24 for ringing; available with upper and lower plywoods 25, 26, the first device 2 is provided with through-holes into which the interlocked main and pinion gears 21, 22, spiral spring wheel 23 and ringing spiral spring 24 can be inserted and also aligned for easy fixation by the upper and lower plywoods 25, 26; several fixed legs 27 are arranged properly around the upper and lower plywoods 25, 26, and both ends of every fixed leg 27 are fix it by nut 271 to form an integrated independent structure.

The second device 3 comprises: time-controlled precision escapement wheel 31, pallet 32, balance spring 33 and balance wheel 34; available also with upper and lower plywoods 35, 36, the second device 3 is provided with through-holes into which the interlocked escapement wheel 31, pallet 32, balance spring 33 and balance wheel 34 can be inserted and also aligned for easy fixation by the upper and lower plywoods 35, 36; at least a fixed leg 37 is arranged properly around the upper and lower plywoods 35, 36, and both ends of every fixed leg 37 are fixed or riveted by nut to form an integrated independent structure.

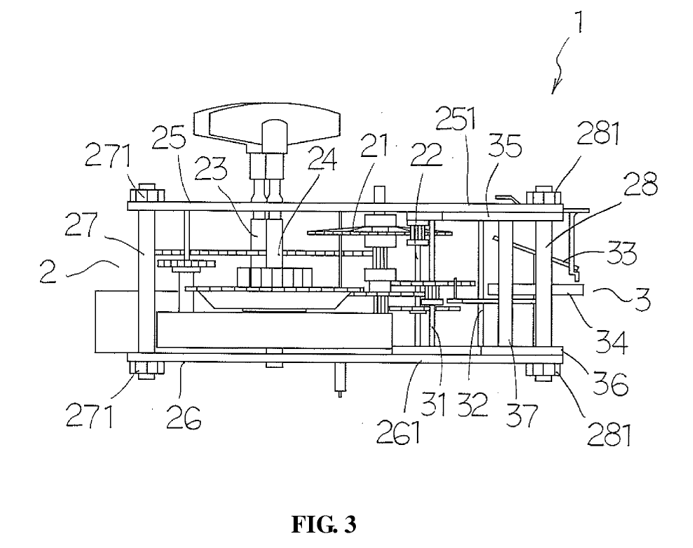

Furthermore, an fixed arm 251, 261 with fixed hole 252, 262 is separately extended from the upper/lower plywood 25, 26 at one side of the first device 2, so as to grip securely the second device 3; round hole 351, 361 is separately set on the upper and lower plywoods 35, 36 of the second device 3, while the plug pin 28 can penetrate simultaneously the fixed hole 252, 262 on the fixed arm 251, 261 of the first device 2, and also the round hole 351, 361 on the upper and lower plywoods 35, 36 of the second device 3; both ends of the plug pin 28 are fastened separately by the nut 281, while the pinion gear 22 in the first device 2 representing a second hand is meshed with the escapement wheel 31 in the second device 3, as shown in FIG. 3

The detachable gear assembly of the present invention is designed specifically to divide the parts of the gear assembly into simple first device and precision second device, both of which can be operated independently and also combined or separated quickly; in the event of common repair or maintenance, the precision second device can be firstly removed to avoid error disassembly or malfunction, and the first device can be operated directly to shorten the time and improve the efficiency of working staff.

As a whole, the “improved detachable clock and gear assembly structure” of the present invention is designed structurally in a way to utilize it more efficiently as a novel utility model, so the following claims are made in full compliance with the requirements of new patent application.

Although the invention has been explained in relation to its preferred embodiment, it is to be understood that many other possible modifications and variations can be made without departing from the spirit and scope of the invention as hereinafter claimed.

1. An improved detachable clock and gear assembly structure, which is equipped with a gear assembly composed of detachable and independent first and second devices; the first device comprises: main and pinion gear representing hour, minute and second hands, spiral spring wheel for storing energy and spiral spring for ringing; the second device comprises: escapement wheel, pallet, balance spring and balance wheel; it is characterized by that:
the first device can clamp securely the main and pinion gears, spiral spring wheel and spiral spring by using upper/lower plywood along with the fixed leg, so can the second device clamp securely the escapement wheel, pallet, balance spring and balance wheel in the same way; moreover, an fixed arm is extended from the upper/lower plywood at one side of the first device to clamp the second device and fix it by bolt for meshing and interlocking purpose.

2. The improved detachable clock and gear assembly structure as claimed in claim 1, wherein fixed hole is set on the fixed arm extended from the upper/lower plywood of the first device, and round hole set on the upper/lower plywood of the second device, so as to insert the plug pin and fasten the both ends by nuts.
